(19) United States
(12) Patent Application Publication
(10) Pub. No.: US 2017/0099427 A1
(43) Pub. Date: Apr. 6, 2017

(54) METHODS AND APPARATUSES FOR PROVIDING IMPROVED AUTOFOCUS USING CURVE-FITTING

(71) Applicant: Google Inc., Mountain View, CA (US)

(72) Inventors: Honglei Wu, Sunnyvale, CA (US); Bo Xu, Mountain View, CA (US); Boyd Albert Fowler, Sunnyvale, CA (US)

(21) Appl. No.: 14/875,646

(22) Filed: Oct. 5, 2015

(51) Int. Cl. H04N 5/232; G02B 7/28

(52) U.S. Cl. CPC H04N 5/23212; G02B 7/28

(57) ABSTRACT

Certain implementations of the disclosed technology may include methods and apparatuses for calculating an optimal lens position for a camera utilizing curve-fitting auto-focus. According to an example implementation, a method (900) is provided. The method (900) may include calculating modulation transfer function values for first and second test image frames associated with respective first and second lens positions of a camera (902, 904). The method may also include identifying, from a database including a plurality of predetermined modulation transfer function curves associated with the camera, a particular predetermined modulation transfer function curve based on the first and second modulation transfer function values (906). The method may also include calculating an optimal lens position for the camera based on the identified particular predetermined modulation transfer function curve (908).

### BACKGROUND

Conventional smartphone cameras often rely on contrast detection (i.e., “peak searching”) in order to perform auto-focus. However, a significant, and undesirable, amount of processing time is required in order to achieve optimal focus utilizing the foregoing methodology. For example, performing autofocus utilizing the contrast detection methodology requires a search for a camera lens position that yields optimal focus. This frequently entails considering and processing a large number of test image frames before arriving at an optimal lens position that will yield optimal focus. Accordingly, improved methods and apparatuses for performing auto-focus are desired.

### BRIEF DESCRIPTION OF THE FIGURES

Reference will now be made to the accompanying Figures, which are not necessarily drawn to scale, and wherein:

FIG. 1 depicts computing system architecture 100, according to an example implementation of the disclosed technology.

FIG. 2 illustrates an exemplary scene for performing auto-focus.

FIG. 3 illustrates an apparatus for performing curve-fitting auto-focus in accordance with an exemplary embodiment of the disclosed technology.

FIG. 4 illustrates a system for generating predetermined modulation transfer function curves associated with a particular camera in accordance with an exemplary embodiment of the disclosed technology.

FIG. 5 illustrates predetermined modulation transfer function curves associated with a particular camera in accordance with an exemplary embodiment of the disclosed technology.

FIG. 6 illustrates predetermined modulation transfer function curves associated with a particular camera, along with calculated modulation transfer function values for a plurality of test images, in accordance with an exemplary embodiment of the disclosed technology.

FIG. 7 illustrates predetermined modulation transfer function curves associated with a particular camera, along with calculated modulation transfer function values for a plurality of test images and a linearly scaled version of one of the predetermined modulation transfer function curves, in accordance with an exemplary embodiment of the disclosed technology.

FIG. 8 illustrates various design choices available for performing the curve-fitting auto-focus methodology described herein, in accordance with exemplary embodiments of the disclosed technology.

FIG. 9 is a flow chart illustrating a method for calculating an optimal lens position for a camera utilizing curve-fitting autofocus in accordance with an exemplary embodiment of the disclosed technology.

FIG. 10 is a flow chart illustrating another method for calculating an optimal lens position for a camera utilizing curve-fitting autofocus in accordance with an exemplary embodiment of the disclosed technology.

FIG. 11 is a flow chart illustrating yet another method for calculating an optimal lens position for a camera utilizing curve-fitting autofocus in accordance with an exemplary embodiment of the disclosed technology.

FIG. 12 is a flow chart illustrating another method for calculating an optimal lens position for a camera utilizing curve-fitting autofocus in accordance with an exemplary embodiment of the disclosed technology.

### DETAILED DESCRIPTION

Some implementations of the disclosed technology will be described more fully with reference to the accompanying drawings. This disclosed technology may, however, be embodied in many different forms and should not be construed as limited to the implementations set forth herein.

Example implementations of the disclosed technology provide methods and apparatuses for calculating an optimal lens position for a camera utilizing curve-fitting autofocus. In addition, example implementations of the disclosed technology provide methods and apparatuses for generating, and storing in a database, predetermined modulation transfer function curves associated with a particular camera.

Example implementations of the disclosed technology will now be described with reference to the accompanying figures.

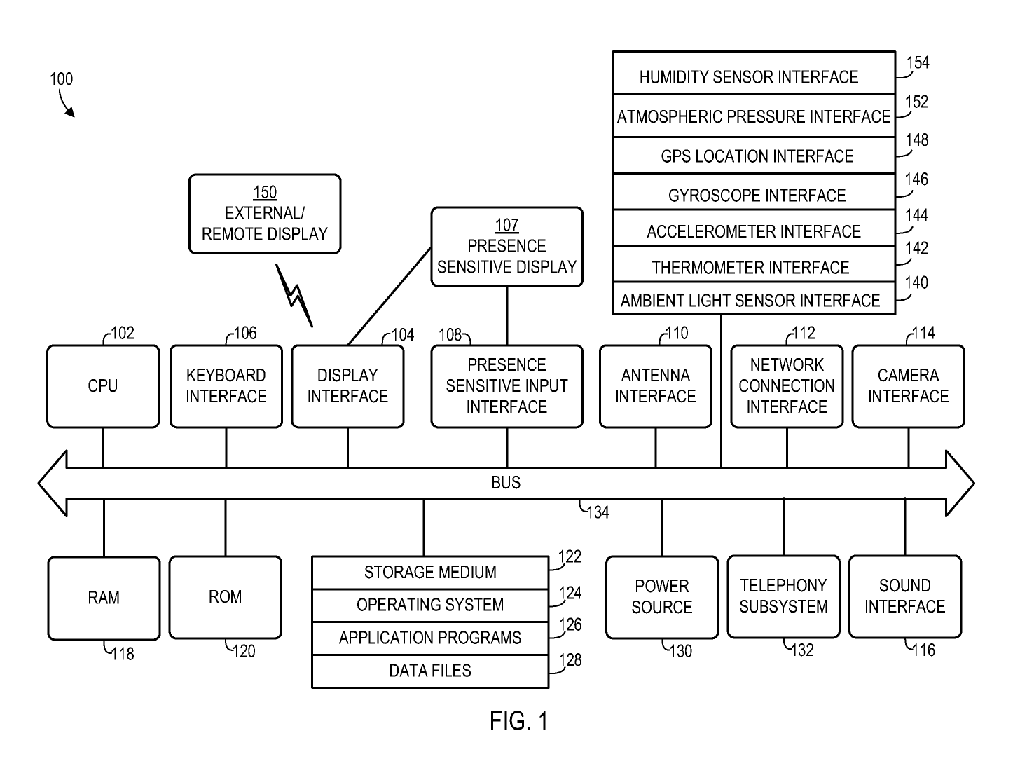

As desired, implementations of the disclosed technology may include a computing device with more or less of the components illustrated in FIG. 1. The computing device architecture 100 is provided for example purposes only and does not limit the scope of the various implementations of the present disclosed systems, methods, and computer-readable mediums.

The computing device architecture 100 of FIG. 1 includes a central processing unit (CPU) 102, where executable computer instructions are processed; a display interface 104 that supports a graphical user interface and provides functions for rendering video, graphics, images, and texts on the display. In certain example implementations of the disclosed technology, the display interface 104 connects directly to a local display, such as a touch-screen display associated with a mobile computing device. In another example implementation, the display interface 104 provides data, images, and other information for an external/remote display 150 that is not necessarily physically connected to the mobile computing device. For example, a desktop monitor can mirror graphics and other information presented on a mobile computing device. In certain example implementations, the display interface 104 wirelessly communicates, for example, via a Wi-Fi channel or other available network connection interface 112 to the external/remote display.

In an example implementation, the network connection interface 112 can be configured as a wired or wireless communication interface and can provide functions for rendering video, graphics, images, text, other information, or any combination thereof on the display. In one example, a communication interface can include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device architecture 100 can include a keyboard interface 106 that provides a communication interface to a physical or virtual keyboard. In one example implementation, the computing device architecture 100 includes a presence-sensitive display interface 108 for connecting to a presence-sensitive display 107. According to certain example implementations of the disclosed technology, the presence-sensitive input interface 108 provides a communication interface to various devices such as a pointing device, a capacitive touch screen, a resistive touch screen, a touchpad, a depth camera, etc. which may or may not be integrated with a display.

The computing device architecture 100 can be configured to use one or more input components via one or more of input/output interfaces (for example, the keyboard interface 106, the display interface 104, the presence sensitive input interface 108, network connection interface 112, camera interface 114, sound interface 116, etc.,) to allow the computing device architecture 100 to present information to a user and capture information from a device's environment including instructions from the device's user. The input components can include a mouse, a trackball, a directional pad, a track pad, a touch-verified track pad, a presence-sensitive track pad, a presence-sensitive display, a scroll wheel, a digital camera including an adjustable lens, a digital video camera, a web camera, a microphone, a sensor, a smartcard, and the like. Additionally, an input component can be integrated with the computing device architecture 100 or can be a separate device. As additional examples, input components can include an accelerometer, a magnetometer, a digital camera, a microphone, and an optical sensor.

Example implementations of the computing device architecture 100 can include an antenna interface 110 that provides a communication interface to an antenna; a network connection interface 112 can support a wireless communication interface to a network. As mentioned above, the display interface 104 can be in communication with the network connection interface 112, for example, to provide information for display on a remote display that is not directly connected or attached to the system. In certain implementations, a camera interface 114 is provided that acts as a communication interface and provides functions for capturing digital images from a camera. In certain implementations, a sound interface 116 is provided as a communication interface for converting sound into electrical signals using a microphone and for converting electrical signals into sound using a speaker. According to example implementations, a random access memory (RAM) 118 is provided, where executable computer instructions and data can be stored in a volatile memory device for processing by the CPU 102.

According to an example implementation, the computing device architecture 100 includes a read-only memory (ROM) 120 where invariant low-level system code or data for basic system functions such as basic input and output (I/O), startup, or reception of keystrokes from a keyboard are stored in a non-volatile memory device. According to an example implementation, the computing device architecture 100 includes a storage medium 122 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), for storing files include an operating system 124, application programs 126 (including, for example, a web browser application, a widget or gadget engine, and or other applications, as necessary), and data files 128. According to an example implementation, the computing device architecture 100 includes a power source 130 that provides an appropriate alternating current (AC) or direct current (DC) to power components.

According to an example implementation, the computing device architecture 100 includes a telephony subsystem 132 that allows the device 100 to transmit and receive audio and data information over a telephone network. Although shown as a separate subsystem, the telephony subsystem 132 may be implemented as part of the network connection interface 112. The constituent components and the CPU 102 communicate with each other over a bus 134.

According to an example implementation, the CPU 102 has appropriate structure to be a computer processor. In one arrangement, the CPU 102 includes more than one processing unit. The RAM 118 interfaces with the computer bus 134 to provide quick RAM storage to the CPU 102 during the execution of software programs such as the operating system, application programs, and device drivers. More specifically, the CPU 102 loads computer-executable process steps from the storage medium 122 or other media into a field of the RAM 118 in order to execute software programs. Data can be stored in the RAM 118, where the data can be accessed by the computer CPU 102 during execution. In one example configuration, the device architecture 100 includes at least 128 MB of RAM, and 256 MB of flash memory.

The storage medium 122 itself can include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system, can be tangibly embodied in storage medium 122, which can include a machine-readable storage medium.

According to one example implementation, the term computing device, as used herein, can be a CPU, or conceptualized as a CPU (for example, the CPU 102 of FIG. 1). In this example implementation, the computing device (CPU) can be coupled, connected, and/or in communication with one or more peripheral devices, such as display. In another example implementation, the term computing device, as used herein, can refer to a mobile computing device such as a smartphone, tablet computer, or smart watch. In this example implementation, the computing device outputs content to its local display and/or speaker(s). In another example implementation, the computing device outputs content to an external display device (e.g., over Wi-Fi) such as a TV or an external computing system.

In example implementations of the disclosed technology, a computing device includes any number of hardware and/or software applications that are executable to facilitate any of the operations. In example implementations, one or more I/O interfaces facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., can facilitate user interaction with the computing device. The one or more I/O interfaces can be utilized to receive or collect data and/or user instructions from a wide variety of input devices. Received data can be processed by one or more computer processors as desired in various implementations of the disclosed technology and/or stored in one or more memory devices.

One or more network interfaces can facilitate connection of the computing device inputs and outputs to one or more suitable networks and/or connections; for example, the connections that facilitate communication with any number of sensors associated with the system. The one or more network interfaces can further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

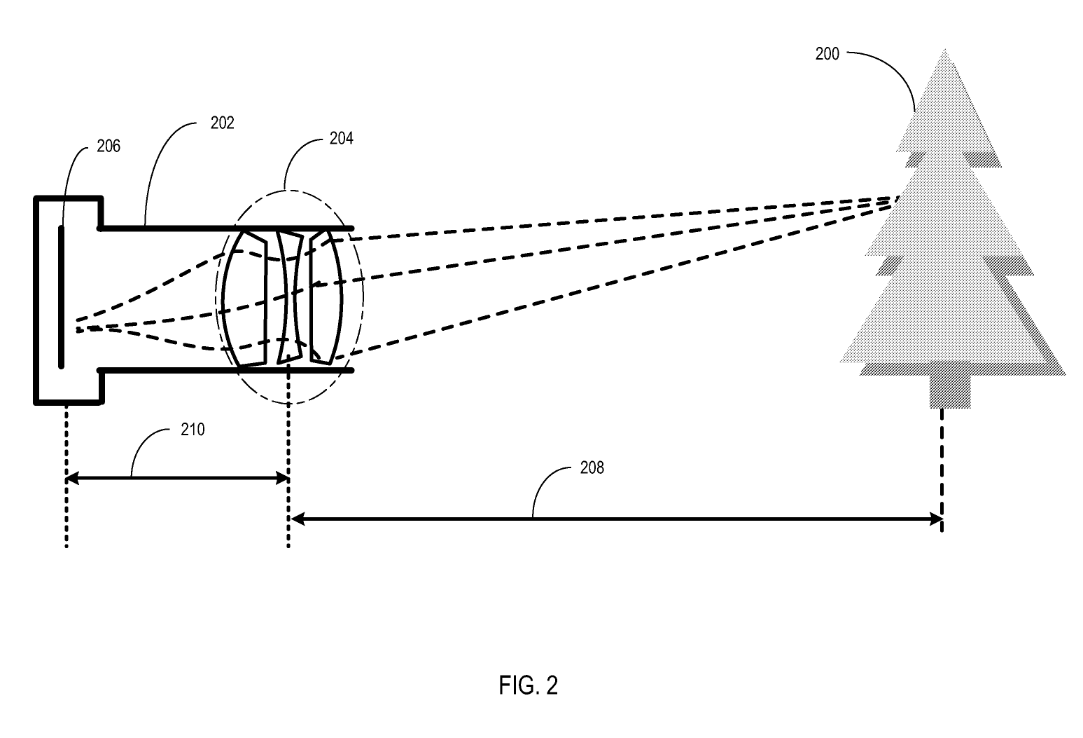

FIG. 2 is an illustration of a scene including an object 200 sought to be photographed by a camera 202 employing an auto-focus methodology. The camera 202 includes a lens 204 for contorting incoming light onto a sensor 206 configured to register the light refracted through the lens 204. The lens 204 is disposed at a particular distance 210 from the sensor, referred to hereinafter as the “lens position.” The camera 202 is disposed at a particular distance 208 from the object 200, referred to hereinafter as the “object distance.” In the example illustrated in FIG. 2, the position of the lens 204 is adjustable about a plane normal to the sensor 206. The sharpness, or clarity, of any images captured by the camera 202 can be manipulated by adjusting the lens position relative to the sensor 206. Auto-focus algorithms are algorithms designed to identify the optimal lens position (e.g., lens position 210) for a camera (e.g., camera 202) in order to achieve the sharpest image of the object (e.g., object 202) sought to be photographed.

While FIG. 2 and the preceding discussion have focused on utilizing an auto-focus algorithm in order to achieve the sharpest image of an object (e.g., object 200), those having ordinary skill in the art will appreciate that target sought to be clearly captured in a photograph taken by a camera (e.g., camera 202) may not necessarily be an object per se, but rather, may be some other content of interest included in the camera's field of view, such content of interest referred to hereinafter as a “region of interest.” By way of example and not limitation, in a scene including a person, the region of interest may include a face of the person.

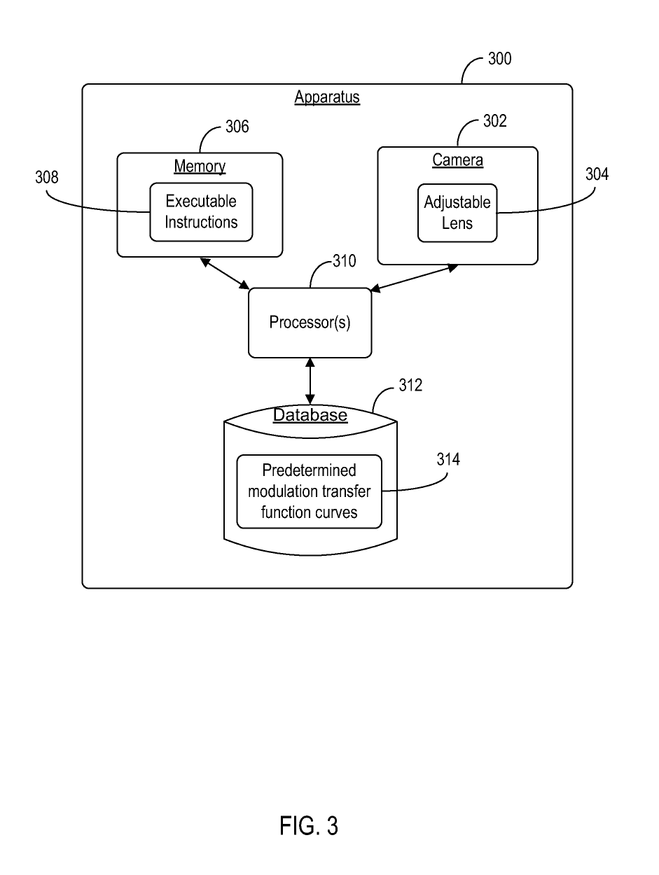

FIG. 3 illustrates an exemplary apparatus 300 suitable for use in performing curve-fitting auto-focus in accordance with the techniques disclosed herein. The apparatus 300 can represent one or more implementations of the computing device architecture 100 described above with regard to FIG. 1. For example, the apparatus 300 can be implemented as a mobile phone, smart phone, tablet, laptop computer, desktop computer, or any other suitable device capable of performing the functionality described herein. The apparatus 300 includes memory 306, a camera 302, one or more processors 310, and a database 312. Although shown separately for purposes of clarity, the database 312 may be stored, in some embodiments, in memory 306. In some embodiments (not shown), the database 312 may be stored remotely from the apparatus 300, but may be accessible by the apparatus 300 via one or more wired or wireless networks.

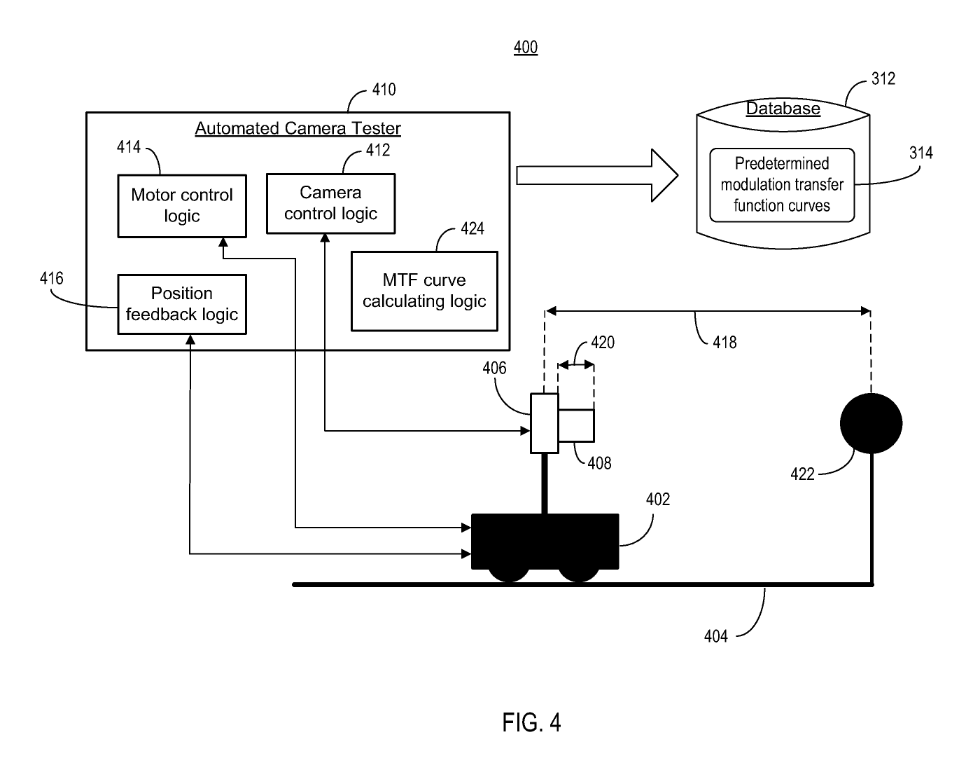

Memory 306 includes executable instructions 308 for directing the operation of the processor(s) 310. In some embodiments, memory 306 also includes data (not shown) to be acted upon by the processor(s) 310. The camera 302 includes an adjustable lens 304. In some examples, the processor(s) 310 executes the executable instructions 308 in order to issue an instruction to adjust the position of the lens 304, so as to perform curve-fitting auto-focus in line with the teachings of this disclosure. The database 312 can include any data bank, data repository or like collection of data files (defined broadly to include any combination of data or records) arranged, for example, for ease and speed of search and retrieval using any database structures (e.g., SQL, NoSQL, object-oriented relational, etc.) known in the art or subsequently developed without departing from the teachings of this disclosure. As shown, the database 312 includes a plurality of predetermined modulation transfer function curves 314 associated with the camera 302. A discussion on the generation and storage of the predetermined modulation transfer function curves 314 is provided below with regard to FIG. 4. In some embodiments, the plurality of predetermined modulation transfer function curves 314 are associated with the camera 302 in the sense that the plurality of predetermined modulation transfer function curves 314 were generated using a test camera substantially similar to the camera 302. For example, in some embodiments, the test camera may be the same make and model as the camera 302.

The camera 302 is operative to capture one or more test image frames as part of the curve-fitting auto-focus methodology set forth herein. As used herein, “test images frames” refer to image frames that are captured by the camera 304 and used to identify an optimal lens position for the camera 304 in order to obtain, or capture, the sharpest image of the target object or region of interest. Test frames may be contrasted with traditional image frames, where traditional images frames are those frames captured after an auto-focus methodology (e.g., the curve-fitting auto-focus methodology described herein) has been employed.

In some embodiments, the processor(s) 310 are configured to execute the executable instructions 308 in order to calculate (i) a first modulation transfer function value for a first test image frame associated with a first lens position of the camera 302 and (ii) a second modulation transfer function value for a second test image frame associated with a second lens position of the camera 302. In addition, the processor(s) 310 may be configured to execute the executable instructions 308 in order to identify, from the database 312, a particular predetermined modulation transfer function curve based on the first and second modulation transfer function values. Further still, the processor(s) 310 may execute the executable instructions 308 in order to (i) calculate an optimal lens position for the camera 302 (i.e., a lens position configured to result in the sharpest captured image of the object or region of interest) based on the identified particular predetermined modulation transfer function curve and (ii) instruct the camera 302 to adjust its lens position to coincide with the calculated optimal lens position.

In some embodiments, it may be desirable to perform additional processing in order to ensure that the optimal lens position identified according to the process set forth above is, indeed, the optimal or “best” lens position for capturing a sharp image of the object or region of interest. In such an embodiment, the processor(s) 310 can be further configured to execute the executable instructions 308 in order to calculate a third modulation transfer function value for a third test image frame associated with the optimal lens position calculated according to the process set forth in the preceding paragraph. In addition, the processor(s) 310 can be further configured to execute the executable instructions 308 in order to re-identify, from the database 312, a particular predetermined modulation transfer function curve based on the third modulation transfer function value. The re-identified particular predetermined modulation transfer function curve may be the same curve identified initially, or it may be a different curve. Continuing, the processor(s) 310 can be further configured to execute the executable instructions 308 in order to re-calculate the optimal lens position for the camera 302 based on the re-indentified particular predetermined modulation transfer function curve. Finally, the processor(s) 310 can be configured to execute the executable instructions 308 in order to issue an instruction to the camera 302 to re-adjust, if necessary (i.e., if the re-calculated optimal lens position differs from the originally calculated optimal lens positions), the lens position for the camera 302 to coincide with the re-calculated optimal lens position.

In some embodiments, the steps of identifying and/or or re-identifying the particular predetermined modulation transfer function curve from the database 312 may include performing phase detection and/or contrast detection in order to identify the particular predetermined modulation transfer function curve. Suitable techniques known to those having ordinary skill in the art for performing phase detection and/or contrast detection can be employed for this purpose. For example, and as known in the art, the following contrast detection techniques may be employed: Sobel filtering, amplitude detection, and/or Sobel filtering in conjunction with amplitude detection.

FIG. 4 illustrates an automated camera tester system 400 suitable for use in generating predetermined modulation transfer curves (e.g., predetermined modulation transfer function curves 314) associated with a camera (e.g., camera 302 shown in FIG. 3) in accordance with embodiments of this disclosure. The automated camera tester system 400 includes a test camera support 402, a motorized test camera rail 404, a test camera 406 having an adjustable lens 408, a test object 422, and an automated camera tester 410 operatively connected to, and in wireless or wired communication with, the test camera 406 and/or test camera support 402.

The test camera support 402 is horizontally movable along the motorized test camera rail 404 such that that the test camera 406 may capture images of the test object 422 at different object distances (e.g., object distance 418 shown in FIG. 4). Any suitable means for moving the test camera support 402 (e.g., one or more mechanical or electrical motors included as part of the test camera support 402 and/or motorized camera rail 404) can be employed for moving the test camera support 402 without deviating from the teachings of this disclosure. In addition, the adjustable lens 408 of the test camera 406 is movable horizontally in order to capture images at different lens positions (e.g., lens position 420 shown in FIG. 4). In some embodiments, the test object 422 may include a test diagram including a black-and-white and/or color pattern, as known in the art. However, the test object 422 can take any number of different configurations without deviating from the teachings of this disclosure.

The automated camera tester 410 includes motor control logic 414, camera control logic 412, position feedback logic 416, and modulation transfer function calculating logic 424. In some implementations, the automated camera tester 410 may take the form of the computing device architecture 100 of FIG. 1. The various automated camera tester logic 412, 414, 416, 424 may take the form of hardware, software, firmware, or any combination thereof in order to achieve the functionality described in this disclosure. The automated camera tester system 400 may be utilized to generate predetermined modulation transfer function curves for the test camera 406 and, consequently, for any camera that exhibits the same mechanical characteristics of the test camera 406, such as other cameras of the same make and model, in accordance with the following discussion.

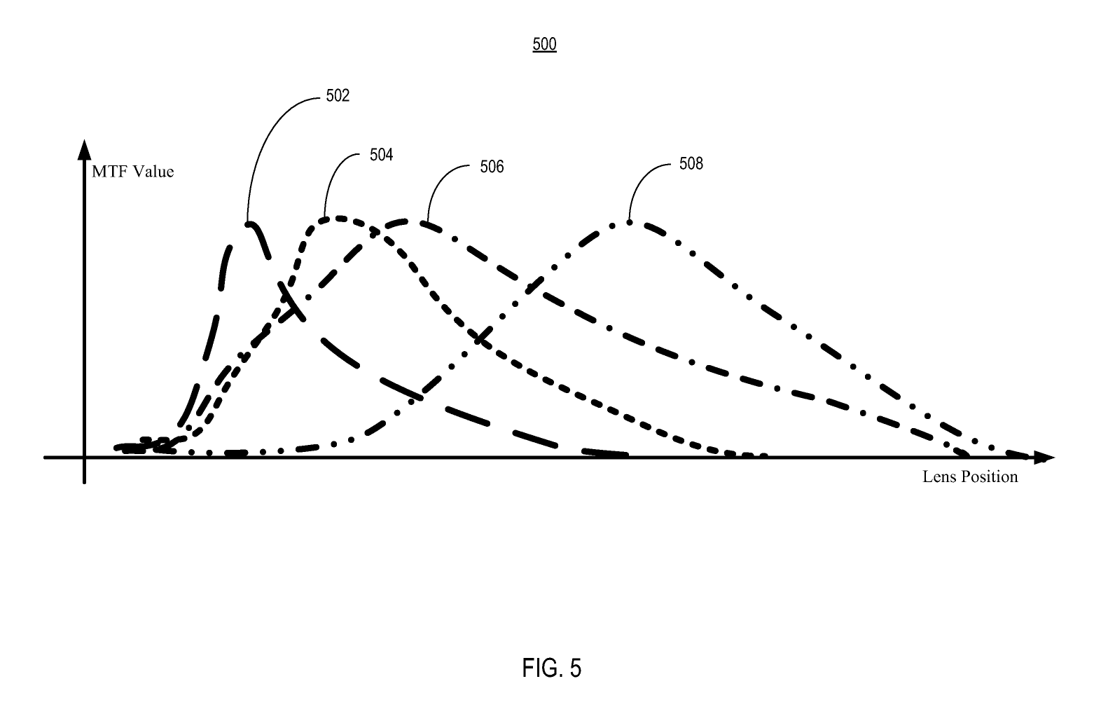

In operation, the automated camera tester system 400 can generate the predetermined modulation transfer function curves 314 (e.g., for storage in database 312) as follows. The motor control logic 414 of the automated camera tester 410 can direct the test camera support 402 (and consequently, the test camera 406 coupled thereto) along the motorized test camera rail 404 to a position corresponding to a first object distance (e.g., object distance 418). The position feedback logic 416 is configured to ascertain the specific position (and, thus, object distance) of the test camera 406 at any given time using techniques known in the art. While positioned at the first object distance, the camera control logic 412 can direct the test camera 406 to capture a plurality of test camera image frames of the test object 422 at a plurality of different lens positions for the lens 408. With regard to each particular captured test camera image frame, the modulation transfer function curve calculating logic 424 is configured to calculate a modulation transfer function value for the test camera image frame using any suitable modulation transfer functional calculation known in the art. Thus, for a given object distance, a plurality of modulation transfer function values corresponding to a plurality of lens positions can be obtained. The plurality of modulation transfer function values for a given object distance can be represented as points making up a curve, where the curve represents all of the calculated modulation transfer function values for all of the captured test camera image frames at the different lens positions. This concept is described in further detail herein with regard to FIG. 5 and the accompanying discussion.

After calculating the modulation transfer function values for the different lens positions at the first object distance, the motor control logic 414 may direct the test camera support 402 (and consequently, the test camera 406 coupled thereto) along the motorized test camera rail 404 to a position corresponding to a second object distance that is different than the first object distance. The position feedback logic 416 is configured to ascertain the second object distance. At the second object distance, the foregoing process may be repeated, such that the camera control logic 412 directs the test camera 406 to capture a plurality of test camera image frames of the test object 422 at a plurality of different lens positions for the lens 408. The modulation transfer function curve calculating logic 424 may then calculate all of the modulation transfer function values for the test camera image frames obtained at the second object distance for all of the different lens positions. In this manner, a second modulation transfer function curve may be generated reflecting a plurality of different modulation transfer function values associated with respective lens positions for the second object distance.

Any suitable number of test camera image frames may be captured at any suitable number of object distances without deviating from the teachings of this disclosure. In some embodiments, the generated plurality of predefined modulation transfer function curves 314 may be stored in a database, such as database 312.

FIG. 5 illustrates a plurality of predetermined modulation transfer function curves (e.g., predetermined modulation transfer function curves 314) associated with a particular camera (e.g., test camera 406) generated in accordance with the teachings of this disclosure. With regard to FIG. 5, four exemplary modulation transfer function curves 502, 504, 506, and 508 are shown. Each curve plots calculated modulation transfer function values obtained from the test camera image frames at the various lens positions for a given object distance. Thus, curve 502 can represent the calculated modulation transfer function values for a plurality of lens positions at a first object distance. Similarly, curve 504 can represent the calculated modulation transfer function values for a plurality of lens positions at a second object distance, curve 506 can represent the calculated modulation transfer function values for a plurality of lens positions at a third object distance, and curve 508 can represent the calculated modulation transfer function values for a plurality of lens positions at a fourth object distance.

The predetermined modulation transfer function curves 502-508 are “predetermined” in the sense that they are generated by an automated camera tester system (e.g., automated camera tester system 400) for later use as part of an auto-focus operation by an electronic device (e.g., apparatus 300) including a camera (e.g., camera 302) with similar auto-focus characteristics. As set forth in additional detail below, an electronic device including a camera may make use of the predetermined modulation transfer function curves (e.g., by accessing a database including the predetermined modulation transfer function curves) in order to quickly identify an optimal lens position for achieving optimal sharpness of an image (or any objects/region(s) of interest therein) as part of an auto-focus operation.

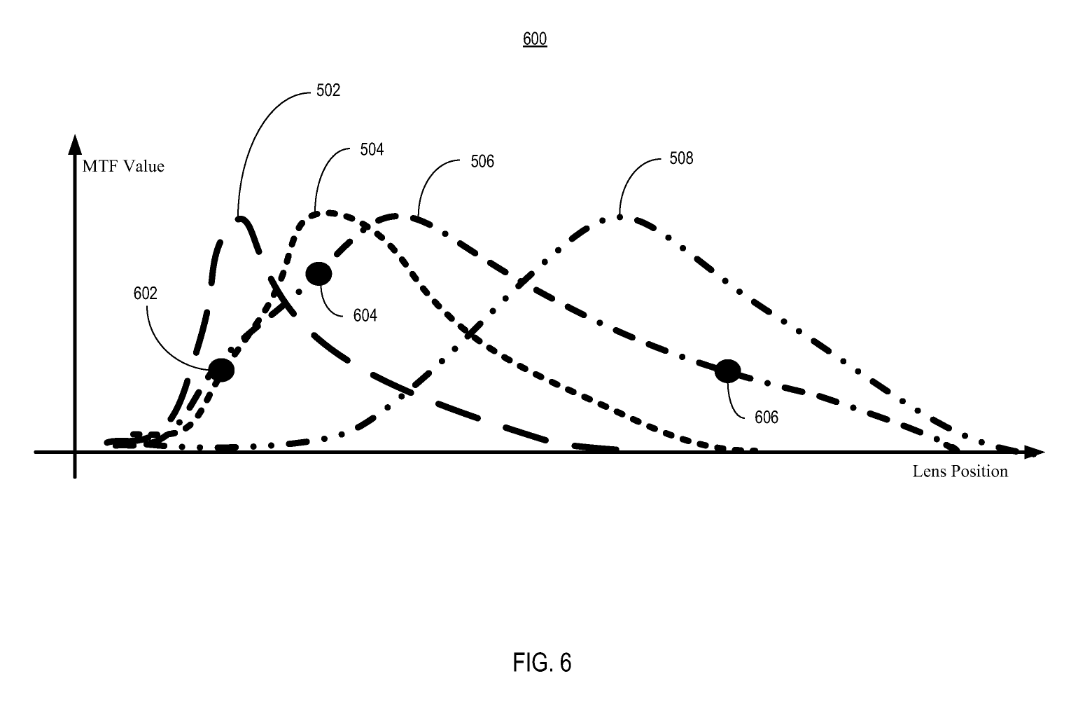

FIG. 6 illustrates (i) a plurality of predetermined modulation transfer function curves associated with a particular camera and (ii) calculated modulation transfer function values for a plurality of test image frames, in accordance with an exemplary embodiment of the disclosed technology. More specifically, FIG. 6 illustrates how the generated plurality of predetermined modulation transfer function curves 502, 504, 506, 508 can be utilized to quickly identify an optimal lens position for a camera as part of a curve-fitting auto-focus operation by comparing the calculated modulation transfer function values for the plurality of test image frames with the curves 502, 504, 506, 508. The points 602, 604, and 606 represent the modulation transfer function values associated with three test image frames, and three corresponding lens positions, captured by a camera (e.g., camera 302 of apparatus 300).

One aim of the curve-fitting auto-focus algorithm set forth herein is to determine which curve (and consequently, which lens position) will yield the sharpest image of the object (or region of interest) by comparing (i) the points representing modulation transfer function values (e.g., points 602, 604, 606) associated with test images captured by the camera with (ii) the predetermined modulation transfer function curves (e.g., curves 502, 504, 506, 508) generated using a test camera that is substantially similar to the camera capturing the test images.

Thus, in the embodiment shown in FIG. 6, a database (e.g., database 312) is already populated with predetermined modulation transfer function curves (e.g., curves 502, 504, 506, 508) generated using a test camera (e.g., test camera 406) in line with the foregoing discussion (see, e.g., FIG. 4 and accompanying discussion). A camera other than the test camera (e.g., camera 302) can then utilize a curve-fitting auto-focus methodology in line with the present disclosure in order to identify an optimal lens positions designed to yield the sharpest image of an object or region of interest as follows. The camera can capture a number of test image frames. Each test image frame can be represented as a modulation transfer function value at a given lens position (i.e., the lens position of the camera at the time that the test image frame was captured) as shown in FIG. 6. Techniques for calculating a modulation transfer function value for a test image frame captured at a given lens position are known to those having ordinary skill in the art.

With continued reference to FIG. 6, after a plurality of modulation transfer function values associated with test image frames captured at a plurality of lens positions are determined, those values (e.g., points 602-606) can be compared with the predetermined modulation transfer function curves (e.g., curves 502, 504, 506, 508) in order to identify a particular predetermined modulation transfer function curve associated with an optimal lens position. In one example, the optimal lens position will coincide with the peak of a given predetermined modulation transfer function curve.

For example, and with continued reference to FIG. 6, point 602 appears to intersect both curve 504 and curve 506. Accordingly, point 602 may not, in and of itself, be sufficient to determine the optimal predetermined modulation transfer function curve that will yield the sharpest image of the object or region of interest. Accordingly, in this example, another test image frame can be captured and a modulation transfer function value corresponding to this test image frame can be calculated. For sake of this example, assume that the modulation transfer function value corresponding to the second test image frame is represented as point 604 of FIG. 6. As shown in FIG. 6, point 604 intersects only curve 506; thus, curve 506 is likely to represent the curve that will yield the optimal lens positions as both points 602 and 604 intersect this curve. However, in this example, additional point(s) of comparison may be desired (e.g., in order to confirm that curve 506 does indeed coincide with the optimal lens position). Accordingly, another (third) test image frame can be captured and a modulation transfer function value corresponding thereto can be calculated. The modulation transfer function value associated with the third test image frame can be represented by point 606 of FIG. 6. At this juncture, it is clear that points 602, 604, and 606 all intersect curve 506. Thus, curve 506 may be determined to coincide with the optimal lens position. Accordingly, the lens position of the camera may be adjusted (e.g., via an instruction issued from processor(s) 310 of apparatus 300) to coincide with the peak of curve 506 in order to achieve optimal sharpness of the object or region of interest when the traditional image frame is captured (i.e., the final photograph is actually taken). In some embodiments, the test image frames captured in order to identify the optimal lens position are discarded after the curve-fitting auto-focus algorithm is performed. In other embodiments, these test image frames are retained (e.g., stored in memory 306 of apparatus 300).

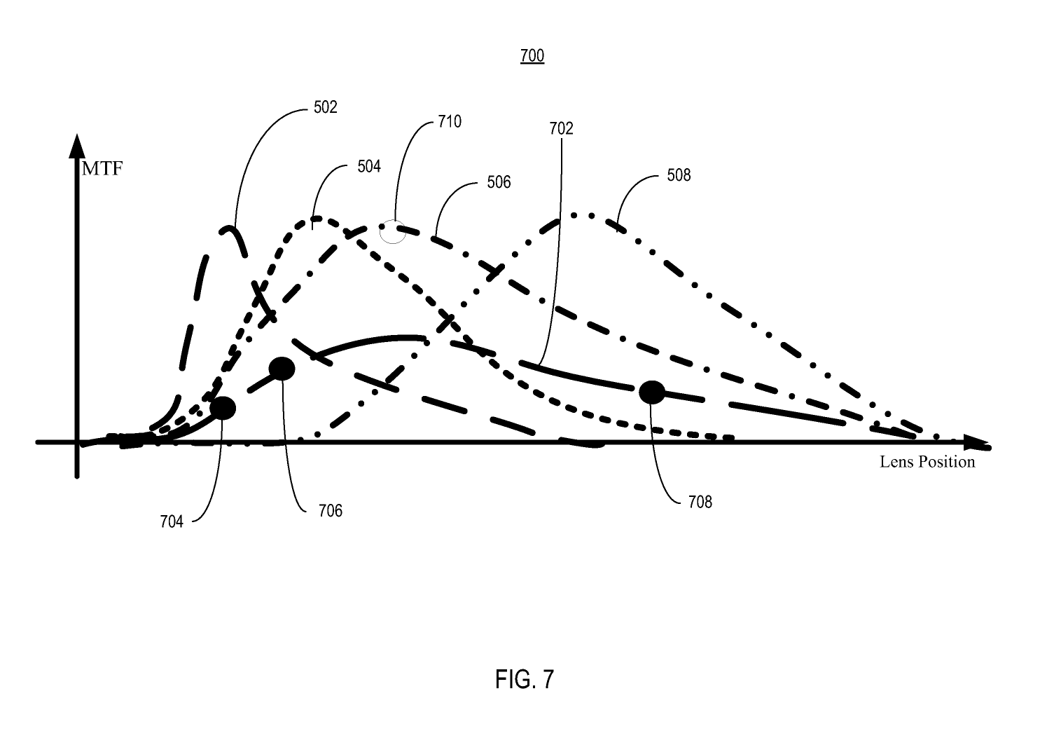

FIG. 7 illustrates one example of how the curve-fitting algorithm disclosed herein may be utilized to identify an optimal lens position when one or more of the modulation transfer function values associated with the test image frames do not directly intersect any of the predetermined modulation transfer function curves. This situation may arise, for example, when the object distance associated with the test image frames differs from the object distance associated with any of the predetermined modulation transfer function curves, or where the object distance is not known.

More specifically, FIG. 7 illustrates (i) a plurality of predetermined modulation transfer function curves (502, 504, 506, and 508) associated with a particular camera; (ii) calculated modulation transfer function values for a plurality of test images (704, 706, and 708); (iii) a linearly scaled version of predetermined modulation transfer function curve 506 (the linearly scaled version represented as reference numeral 702); and (iv) a calculated optimal lens position 710 (where all of the foregoing (i)-(iv) are represented as reference numeral 700).

The process for generating the predetermined modulation transfer function curves 502, 504, 506, 508 and calculating the modulation transfer function values associated with the test images 704, 706, 708 can be carried out in line with the foregoing discussion concerning FIG. 6. However, at this stage, it may be determined that some, or all, of the modulation transfer function values associated with the test images 704, 706, 708 do not intersect the same predetermined modulation transfer function curve. Accordingly, the curve-fitting algorithm set forth herein may further include determining whether the modulation transfer function values associated with the test images 704, 706, 708 coincide with a linearly scaled version of any of the predetermined modulation transfer function curves. Thus, as shown in FIG. 7, it is determined that the modulation transfer function values associated with the test images 704, 706, 708 coincide with a linearly scaled version of predetermined modulation transfer function curve 506, where the linearly scaled version of curve 506 is represented as curve 702. Because points 704, 706, 708 all intersect the linearly scaled curve 702, curve 506 may be identified as the particular predetermined modulation transfer function curve, and the peak of curve 506 (represented as reference numeral 710) may identify the optimal lens position.

In some embodiments, determining whether a linearly scaled version of any of the predetermined modulation transfer function curves correspond to the modulation transfer function values associated with the test images includes determining a difference between (i) a first modulation transfer function value for a first test image at a first lens position and (ii) a modulation transfer function value at the first lens position corresponding to a linearly scaled version of any of the predetermined modulation transfer function curves. Thus, with reference back to FIG. 7, this step may entail calculating a difference between the modulation transfer function value for a test image taken at a first lens position (e.g., point 706) and the modulation transfer function value at the same lens position along one or more of the predetermined modulation transfer function curves (e.g., curves 502, 504, 506, 508 and their respective scaling values). This process may be carried out as many times as necessary in order to identify the particular predetermined modulation transfer function curve associated with the optimal lens position.

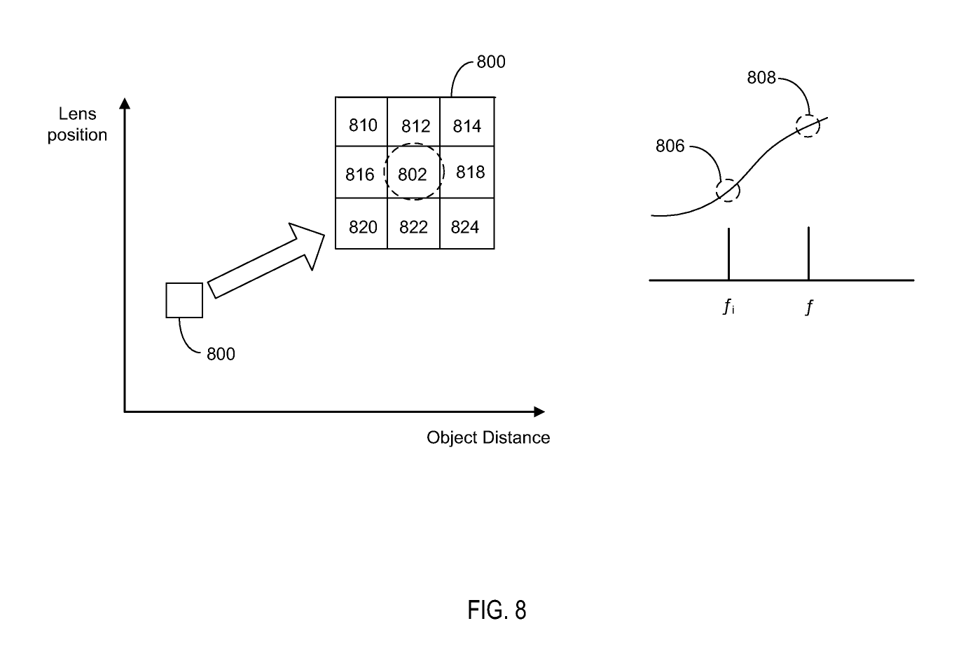

FIG. 8 illustrates various design choices available for performing the curve-fitting auto-focus methodology described herein. As described above, an image frame 800 may be captured by a camera at a particular lens position for the camera and at a particular object distance. For simplicity, the image frame 800 is shown having nine regions 802, 810, 812, 814, 816, 818, 820, 822, and 824. However, those having ordinary skill in the art will appreciate that a given image frame may be composed of any suitable number of regions without departing from the teachings of this disclosure. As shown in FIG. 8, region 802 has been selected as the region of interest. As such, a modulation transfer function can be calculated for region of interest 802 in order to develop a modulation transfer function value for image frame 800 in line with the foregoing discussion. However, in some embodiments, another region can be selected as the region of interest. For example, rather than selecting region 802 as the region of interest, region 810 can be selected as the region of interest.

In other embodiments, modulation transfer function values may be calculated for a plurality of different regions (e.g., regions 810, 812, and 814) of the same image frame (e.g., image frame 800). Then, a particular region of interest may be selected as the region of interest to utilize in generating the modulation transfer function value for that image frame. In determining which region of interest to select, parameters such as data confidence and/or image content relevance may be utilized.

In another embodiment, rather than looking at a region of interest of an image frame, modulations transfer functions may be calculated for one or more spatial frequencies, such as spatial frequency fi 806 and/or spatial frequency f 808. As with the foregoing discussion concerning regions of interest, a particular spatial frequency may be selected as the spatial frequency to utilize in generating the modulation transfer function value for that image frame. In determining which spatial frequency to select, parameters such as data confidence and/or image content relevance may be utilized. Similarly, rather than selecting a particular spatial frequency to utilize in generating the modulation transfer function value for an image frame, a spatial direction may be utilized. The particular spatial direction to utilize may be based on parameters such as data confidence and/or image content relevance.

Finally, in some embodiments, modulation transfer function values may be calculated across one or more regions of interest, one or more spatial frequencies, and one or more spatial directions. In such an embodiment, the selection of which particular region of interest, spatial frequency, or spatial direction to utilize in generating a modulation transfer function value for that image frame may be based on parameters such as data confidence and/or image content relevance.

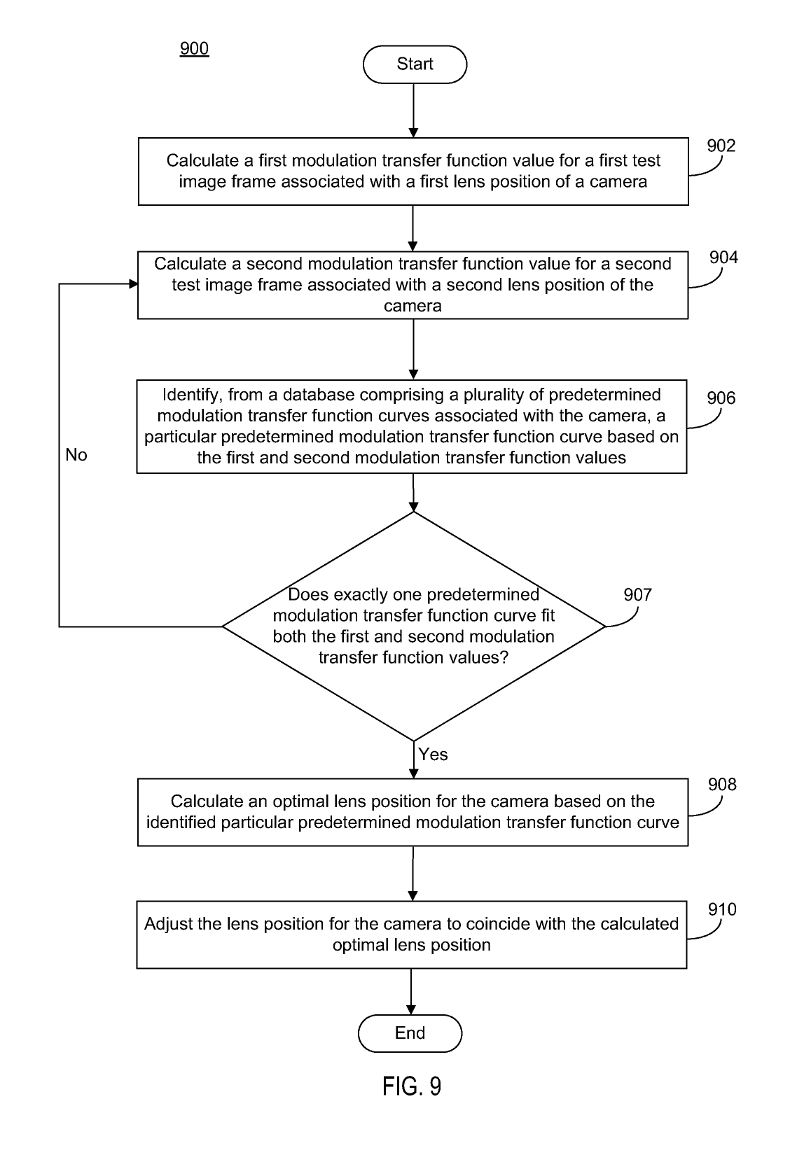

FIG. 9 is a flow chart of a method 900 according to an example implementation of the disclosed technology. The method 900 begins at block 902 where a processor, such as processor(s) 310 of FIG. 3, calculates a first modulation transfer function value for a first test image frame associated with a first lens position of a camera, such as camera 302. As discussed herein with regard to FIGS. 9-12, any calculated modulation transfer function may correspond to a particular object or region of interest within any test image frame, and the determination of which object and/or region of interest to select may be based on parameters such as data confidence and/or image content relevance, as discussed above with regard to FIG. 8. At block 904, the processor calculates a second modulation transfer function value for a second test image frame associated with a second lens position of the camera. At block 906, the processor identifies a particular predetermined modulation transfer function curve from a database including a plurality of predefined modulation transfer function curves associated with the camera. The particular predetermined modulation transfer function curve may be identified based on the first and second modulation transfer function values. If the two modulation transfer function values are not sufficient to differentiate a single predetermined modulation transfer function curve, additional modulation transfer function values may be obtained by returning to block 904 and re-evaluating whether a predetermined modulation transfer function curve can be identified based on the previous and additional modulation transfer function values, as shown at block 907. As shown, block 907 asks whether exactly one predetermined modulation transfer function curve fits the first, second, and any additional modulation transfer function values. As block 904 contemplates calculating one or more subsequent second modulation transfer function value(s) (e.g., because a determination is made at step 907 that exactly one predetermined modulation transfer function curve does not fit the first and second modulation transfer function values), it is noted that any subsequently calculated second modulation transfer function value(s) do not overwrite the first calculated “second modulation transfer function value.” A predetermined modulation transfer function curve may “fit” one or more modulation transfer function values if it intersects the values, or is within a predefined threshold of the values. At block 908, the processor calculates an optimal lens position for the camera based on the identified predetermined modulation transfer function curve. Finally, at block 910, the lens position for the camera may be adjusted to coincide with the calculated optimal lens position.

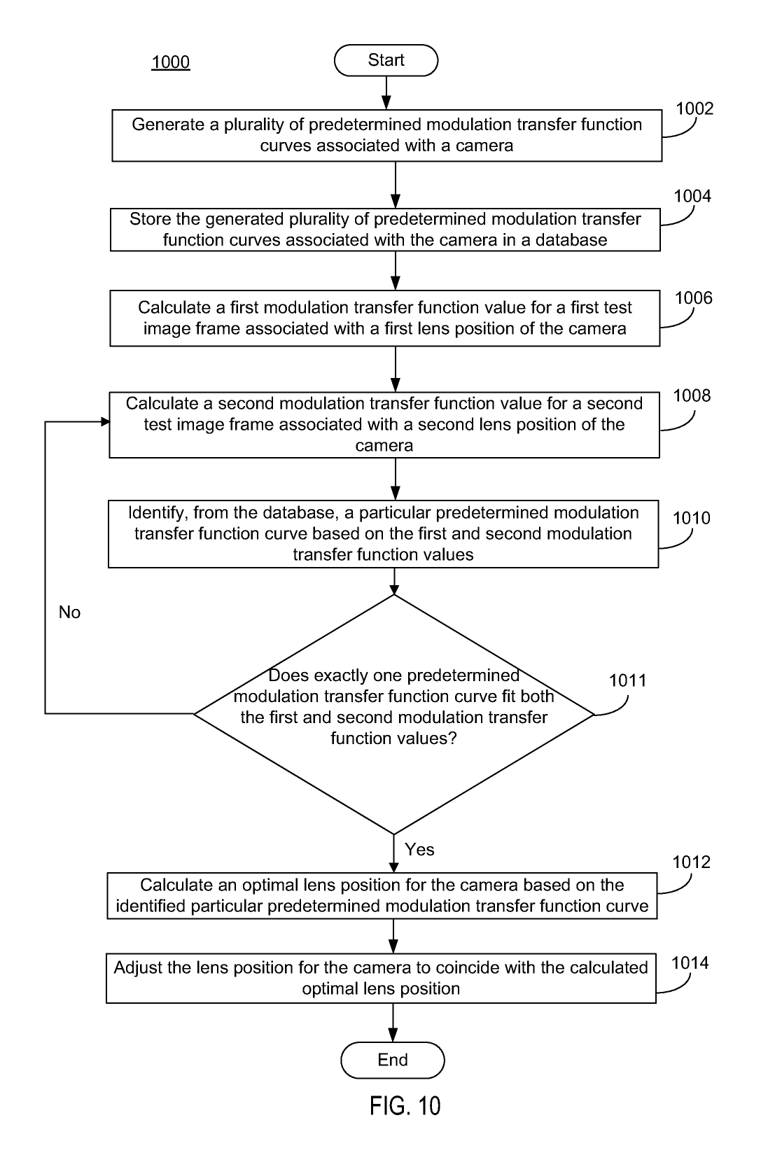

FIG. 10 is a flow chart of a method 1000 according to another example implementation of the disclosed technology. The method 1000 begins at block 1002 where a processor (e.g., MTF curve calculating logic 424 of FIG. 4) generates a plurality of predefined modulation transfer function curves associated with a camera (e.g., test camera 406 of FIG. 4 and/or camera 302 of FIG. 3). At block 1004, the processor stores the generated plurality of predefined modulation transfer function curves associated with the camera in a database (e.g., database 312). At block 1006, another processor (e.g., processor(s) 310 of FIG. 3) calculates a first modulation transfer function value for a first test image frame associated with a first lens position of a camera (e.g., camera 302). At block 1008, the other processor calculates a second modulation transfer function value for a second test image frame associated with a second lens position of the camera. At block 1010, the other processor identifies a particular predetermined modulation transfer function curve from a database including the generated plurality of predefined modulation transfer function curves. The particular predetermined modulation transfer function curve can be identified based on the first and second modulation transfer function values. At block 1011, the other processor determines whether exactly one predetermined modulation transfer function curve fits both the first and second modulation transfer function values. If exactly one predetermined modulation transfer function curve does not fit both the first and second modulation transfer function values, the process may return to block 1008 where an additional modulation transfer function value may be obtained before proceeding again to block 1010 where a determination may be made as to whether exactly one predetermined modulation transfer function curve fits (now) the first, second, and any additional modulation transfer function values. As block 1008 contemplates calculating one or more subsequent second modulation transfer function value(s) (e.g., because a determination is made at step 1011 that exactly one predetermined modulation transfer function curve does not fit the first and second modulation transfer function values), it is noted that any subsequently calculated second modulation transfer function value(s) do not overwrite the first calculated “second modulation transfer function value.” If exactly one predetermined modulation transfer function curve does fit the modulation transfer function values, the process may proceed to block 1012 where the other processor calculates an optimal lens position for the camera based on the identified predetermined modulation transfer function curve. Finally, at block 1014, the lens position for the camera may be adjusted to coincide with the calculated optimal lens position.

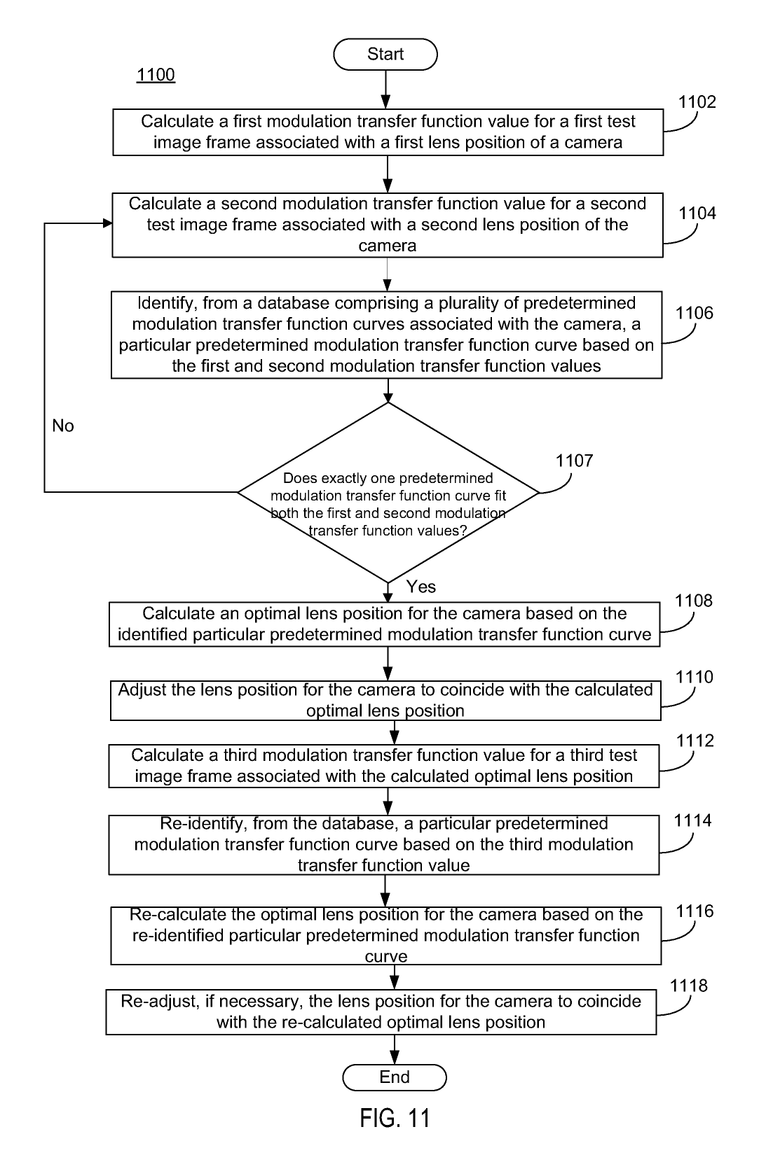

FIG. 11 is a flow chart of a method 1100 according to yet another example implementation of the disclosed technology. The method 1100 begins at block 1102 where a processor (e.g., processor(s) 310 of FIG. 3) calculates a first modulation transfer function value for a first test image frame associated with a first lens position of a camera. At block 1104, the processor calculates a second modulation transfer function value for a second test image frame associated with a second lens position of the camera. At block 1106, the processor identifies a particular predetermined modulation transfer function curve from a database including a plurality of predefined modulation transfer function curves associated with the camera. The particular predetermined modulation transfer function curve can be identified based on the first and second modulation transfer function values. At block 1107, the processor determines whether exactly one predetermined modulation transfer function curve fits both the first and second modulation transfer function values. If exactly one predetermined modulation transfer function curve does not fit both the first and second modulation transfer function values, the process may return to block 1104 where an additional modulation transfer function value may be obtained before proceeding again to block 1106 where a determination may be made as to whether exactly one predetermined modulation transfer function curve fits (now) the first, second, and any additional modulation transfer function values. As block 1104 contemplates calculating one or more subsequent second modulation transfer function value(s) (e.g., because a determination is made at step 1107 that exactly one predetermined modulation transfer function curve does not fit the first and second modulation transfer function values), it is noted that any subsequently calculated second modulation transfer function value(s) do not overwrite the first calculated “second modulation transfer function value.” If exactly one predetermined modulation transfer function curve does fit the modulation transfer function values, the process may proceed to block 1108 where the other processor calculates an optimal lens position for the camera based on the identified predetermined modulation transfer function curve. At block 1110, the lens position for the camera may be adjusted to coincide with the calculated optimal lens position. At block 1112, the processor calculates a third modulation transfer function value for a third test image frame associated with the calculated optimal lens position. At block 1114, the processor re-identifies a particular predefined modulation transfer function curve from the database based on the third modulation transfer function value. At block 1116, the processor re-calculates an optimal lens position for the camera based on the re-identified particular predetermined modulation transfer function curve. Finally, at block 1118, the lens position for the camera may be re-adjusted, if necessary, to coincide with the re-calculated optimal lens position.

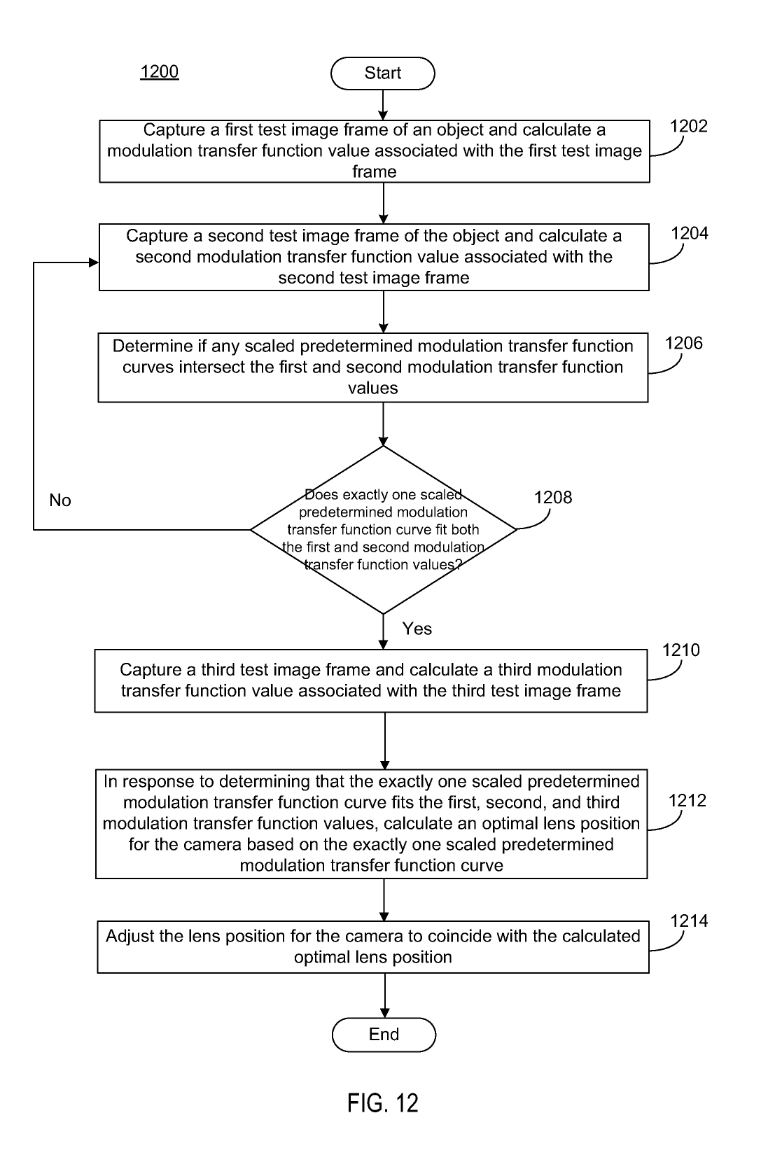

FIG. 12 is a flow chart of a method 1200 according to yet another example implementation of the disclosed technology. The method 1200 begins at block 1202 where a camera (e.g., camera 302 of FIG. 3) captures a first test image frame of an object. At block 1202, a processor (e.g., processor(s) 310 of FIG. 3) calculates a modulation transfer function value associated with the first test image frame. At block 1204, the camera captures a second test image frame of the object. At block 1204, the processor calculates a modulation transfer function value associated with the second test image frame. At block 1206, the processor determines if any scaled predetermined modulation transfer function curves intersect the first and second modulation transfer function values. At block 1208, the processor determines whether exactly one scaled predetermined modulation transfer function curve fits both the first and second modulation transfer function values. If exactly one scaled predetermined modulation transfer function curve does not fit both the first and second modulation transfer function values, the process may return to block 1204 where an additional test image frame may be captured and an additional modulation transfer function value associated therewith may be calculated before proceeding again to block 1206 where a determination may be made as to whether exactly one scaled predetermined modulation transfer function curve fits (now) the first, second, and any additional modulation transfer function values. As block 1204 contemplates calculating one or more subsequent second modulation transfer function value(s) (e.g., because a determination is made at step 1208 that exactly one predetermined modulation transfer function curve does not fit the first and second modulation transfer function values), it is noted that any subsequently calculated second modulation transfer function value(s) do not overwrite the first calculated “second modulation transfer function value.” If exactly one scaled predetermined modulation transfer function curve does fit the modulation transfer function values, the process may proceed to block 1210 where the camera captures a third test image frame. At block 1210, the processor calculates a third modulation transfer function value associated with the third test image frame. At block 1212, in response to determining that the exactly one scaled predetermined modulation transfer function curve fits the first, second, and third modulation transfer function values, the processor calculates an optimal lens position for the camera based on the exactly one scaled predetermined modulation transfer function curve. At block 1214, the lens position for the camera may be adjusted to coincide with the calculated optimal lens position.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, Internet tablets, PDAs, ultra mobile PCs (UMPCs) and smartphones.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method comprising:
calculating, by a processor, a first modulation transfer function value for a first test image frame associated with a first lens position of a camera;
calculating, by the processor, a second modulation transfer function value for a second test image frame associated with a second lens position of the camera;
identifying, by the processor from a database comprising a plurality of predetermined modulation transfer function curves associated with the camera, a particular predetermined modulation transfer function curve based on the first and second modulation transfer function values;
calculating, by the processor, an optimal lens position for the camera based on the identified particular predetermined modulation transfer function curve; and
adjusting the lens position for the camera to coincide with the calculated optimal lens position.

2. The method of claim 2, wherein identifying the particular predetermined modulation transfer function curve based on the first and second modulation transfer function values comprises determining whether a linearly scaled version of any of the plurality of predetermined modulation transfer function curves correspond to the first and second modulation transfer function values.

3. The method of claim 2, wherein determining whether the linearly scaled version of any of the plurality of predetermined modulation transfer function curves correspond to the first and second modulation transfer function values comprises:
determining a difference between the first modulation transfer function value at the first lens position and a modulation transfer function value at the first lens position corresponding to the linearly scaled version of any of the plurality of predetermined modulation transfer function curves.

4. The method of claim 3, wherein determining whether the linearly scaled version of any of the plurality of predetermined modulation transfer function curves correspond to the first and second modulation transfer function values further comprises:
determining whether the linearly scaled version of any of the plurality of predetermined modulation transfer function curves intersect both of the first and second modulation transfer function values.

5. The method of claim 1, further comprising:
generating the plurality of predetermined modulation transfer function curves associated with the camera; and
storing the generated plurality of predetermined modulation transfer function curves associated with the camera in the database.

6. The method of claim 5, wherein generating the plurality of predetermined modulation transfer function curves associated with the camera comprises:
capturing, by a test camera that is substantially equivalent to the camera with regard to mechanical characteristics, a first test camera image frame of an object at a first distance from the test camera to the object and at a first lens position for the test camera;
capturing, by the test camera, a second test camera image frame of the object at the first distance from the test camera to the object and at a second lens position for the test camera;
capturing, by the test camera, a third test camera image frame of the object at a second distance from the test camera to the object and at the first lens position for the test camera; and
capturing, by the test camera, a fourth test camera image frame of the object at the second distance from the test camera to the object and at the second lens position for the test camera.

7. The method of claim 6, further comprising:
calculating respective modulation transfer function curves for the test camera based on the captured first, second, third, and fourth test camera image frames of the object, wherein each respective modulation transfer function curve represents modulation transfer function values at different lens positions for the test camera for the object at a particular distance from the test camera.

8. The method of claim 1, further comprising:
in response to adjusting the lens position for the camera to coincide with the calculated optimal lens position, calculating, by the processor, a third modulation transfer function value for a third test image frame associated with the calculated optimal lens position;
re-identifying, by the processor from the database, a particular predetermined modulation transfer function curve based on the third modulation transfer function value;
re-calculating, by the processor, the optimal lens position for the camera based on the re-indentified particular predetermined modulation transfer function curve; and
re-adjusting, if necessary, the lens position for the camera to coincide with the re-calculated optimal lens position.

9. The method of claim 1, wherein identifying the particular predetermined modulation transfer function curve based on the first and second modulation transfer function values further comprises:
determining whether exactly one predetermined modulation transfer function curve fits both the first and second modulation transfer function values;
in response to determining that exactly one predetermined modulation transfer function curve does not fit both the first and second modulation transfer function values, calculating a third modulation transfer function value for a third test image frame associated with a third lens position of the camera; and
determining whether exactly one predetermined modulation transfer function curve fits the first, second, and third modulation transfer function values.

10. The method of claim 1, wherein identifying the particular predetermined modulation transfer function curve based on the first and second modulation transfer function values further comprises:
performing contrast detection to identify the particular predetermined modulation transfer function curve.

11. A method comprising:
capturing, by a test camera, a first test camera image frame of an object at a first distance from the test camera to the object and at a first lens position for the test camera;
capturing, by the test camera, a second test camera image frame of the object at the first distance from the test camera to the object and at a second lens position for the test camera;
capturing, by the test camera, a third test camera image frame of the object at a second distance from the test camera to the object and at the first lens position for the test camera;
capturing, by the test camera, a fourth test camera image frame of the object at the second distance from the test camera to the object and at the second lens position for the test camera; and
generating, by a processor, a plurality predetermined modulation transfer function curves associated with the test camera based on the captured first through fourth test camera image frames of the object; and
storing, by the processor, the generated plurality of predetermined modulation transfer function curves associated with the test camera in a database.

12. The method of claim 11, wherein generating the plurality of predetermined modulation transfer function curves associated with the test camera comprises calculating respective modulation transfer function curves for test camera based on the captured first through fourth test camera image frames of the object, wherein each respective modulation transfer function curve represents modulation transfer function values at different lens positions for the test camera for the object at a particular distance from the test camera.

13. The method of claim 11, further comprising:
calculating, by a processor, a first modulation transfer function value for a first test image frame associated with a first lens position of a camera;
calculating, by the processor, a second modulation transfer function value for a second test image frame associated with a second lens position of the camera;
identifying, by the processor from the database comprising the generated plurality of predetermined modulation transfer function curves associated with the test camera, a particular predetermined modulation transfer function curve based on the first and second modulation transfer function values;
calculating, by the processor, an optimal lens position for the camera based on the identified particular predetermined modulation transfer function curve; and
adjusting the lens position for the camera to coincide with the calculated optimal lens position.

14. The method of claim 13, wherein the test camera is substantially equivalent to the camera with regard to mechanical characteristics.

15. The method of claim 13, further comprising:
in response to adjusting the lens position for the camera to coincide with the calculated optimal lens position, calculating, by the processor, a third modulation transfer function value for a third test image frame associated with the calculated optimal lens position;
re-identifying, by the processor from the database, a particular predetermined modulation transfer function curve based on the third modulation transfer function value;
re-calculating, by the processor, the optimal lens position for the camera based on the re-indentified particular predetermined modulation transfer function curve; and
re-adjusting, if necessary, the lens position for the camera to coincide with the re-calculated optimal lens position.

16. The method of claim 13, wherein identifying the particular predetermined modulation transfer function curve based on the first and second modulation transfer function values further comprises:
determining whether exactly one predetermined modulation transfer function curve fits both the first and second modulation transfer function values;
in response to determining that exactly one predetermined modulation transfer function curve does not fit both the first and second modulation transfer function values, calculating a third modulation transfer function value for a third test image frame associated with a third lens position of the camera; and
determining whether exactly one predetermined modulation transfer function curve fits the first, second, and third modulation transfer function values.

17. The method of claim 13, wherein identifying the particular predetermined modulation transfer function curve based on the first and second modulation transfer function values further comprises performing contrast detection to identify the particular predetermined modulation transfer function curve.

18. An apparatus comprising:
memory comprising executable instructions; and
a processor operatively connected to the memory, wherein the processor is configured to execute the executable instructions in order to effectuate a method comprising:
calculating a first modulation transfer function value for a first test image frame associated with a first lens position of a camera;
calculating a second modulation transfer function value for a second test image frame associated with a second lens position of the camera;
identifying, from a database comprising a plurality of predetermined modulation transfer function curves associated with the camera, a particular predetermined modulation transfer function curve based on the first and second modulation transfer function values; and
calculating an optimal lens position for the camera based on the identified particular predetermined modulation transfer function curve.

19. The apparatus of claim 18, wherein the executable instructions, when executed by the processor, cause the processor to effectuate the method further comprising:
generating an instruction to adjust the lens position for the camera to coincide with the calculated optimal lens position.

20. The apparatus of claim 18, wherein identifying the particular predetermined modulation transfer function curve based on the first and second modulation transfer function values comprises determining whether a linearly scaled version of any of the plurality of predetermined modulation transfer function curves correspond to the first and second modulation transfer function values.
